(19) United States
(12) Patent Application Publication
(10) Pub. No.: US 2008/0300959 A1
(43) Pub. Date: Dec. 4, 2008

(54) ENTERPRISE APPLICATION PROCUREMENT SYSTEM

(75) Inventors: Anupam SINHA, Bangalore (IN); Subhonil Ghoshal, Mountain View, CA (US); Subrata DUTTA, Kolkata (IN); Elango PRASAD, Hyderabad (IN)

Correspondence Address: KENYON & KENYON LLP, ONE BROADWAY, NEW YORK, NY, 10004, US

(73) Assignee: GENPACT GLOBAL HOLDINGS, S.A.R.L., SICAR, Val-Sainte-Croix (LU)

(21) Appl. No.: 11/755,147

(22) Filed: May 30, 2007

(51) Int. Cl. G06Q 30/00; G06Q 90/00; G07G 1/00; G06F 17/30

(52) U.S. Cl. 705/10; 705/26; 707/104.1

(57) ABSTRACT

An intermediate processing layer provides for the inclusion of procurement functionalities of a multi-level enterprise business application by bridging processing and other operational gaps in the enterprise application. The invention further includes the methodology for operating the procurement management system including numerous processing steps or operations, which may be guided in part based on software-based executable instructions or guidelines incorporated into or governing the executable operations. The procurement system includes four defined portals, a procurement portal, a sourcing portal, a reporting portal, and a supplier portal. The procurement system further includes additional levels of support, information or other layers of user interface. These portals and layers are disposed within existing processing components of the business enterprise suite and provide an interactive component to various users, specifically through the portals.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to an electronic procurement system and more specifically to an intermediate processing layer included within an existing procurement application or suite of applications providing for intermediate-level functionality between high level functions or applications.

A ubiquitous enterprise computing system provides almost countless benefits to the commercial environment, with significant improvements in productivity and interconnectivity between different commercial parties. There are many existing software platforms providing various levels of improved processing efficiency for the commercial environment, including specialized applications for specific functionalities.

The business procurement arena is one specialized business software application. Various enterprise-wide software applications provide different levels of interaction, typically managing the many aspects to the transactions. These enterprise-wide software applications include numerous high level applications for accomplishing specified tasks for each of the parties involved, such as the sales people, the manufacturing or acquisition department, the shipping department, billing or accounting departments and possibly also customer service. The software applications can also provide for management oversight or modeling operations to better manage, track or otherwise gauge business activities.

For example, a current procurement suite, such as a procurement application suite available from Oracle, has numerous applications and portals for performing the core procurement functionalities. Although, this application suite has numerous limitations relating to interacting with various users and other processing systems. For example, the current procurement suite includes applications relating to procurement operations, sourcing operations, supplier operations, business intelligence operations, quality controls, supplier database management, service procedures, procurement contract management, RFID management and interaction with mobile devices, among other applications. These various applications in the suite provide distinct functionality with some level of integrated functionality across the platforms.

Though, existing enterprise software applications are sold in a “one size fits all” technique. The base applications are created and then, upon a customer's purchase, may be customized or otherwise modified to fit the customer's application. Often times, this includes additional expenses beyond the purchase of the software application, as the customer also must pay for an installation and customization of the application for the particular use. This technique is not only expensive, but also very time consuming. These features add to the total cost of ownership for any software application, while also delaying a company's ability to implement purchased software while the installation and customization must be performed.

In the existing procurement suite application, the numerous applications provide the foundation or common platform for customization. The various aspects of these components may be modified or otherwise tweaked by implementation experts in regards to the user's specific need or purpose.

Therefore, there exists a need for a procure to pay solution which may be software-based providing for the direct implementation or otherwise execution of a procurement suite, including the various procurement suite applications, without the customization or other installation activities that make the current systems usable for a purchasing customer.

### BRIEF DESCRIPTION OF THE DRAWINGS

FIG. 1 illustrates one embodiment of an apparatus for providing operative functionality in a procurement system;

FIG. 2 illustrates a functional lay-out diagram of the operations of the apparatus of FIG. 1;

FIG. 3 illustrates a flow diagram of the operative functions of the procurement, in accordance with one embodiment of the present invention;

FIG. 4 illustrates one embodiment of a sample screen shot allowing an interface for interaction with the procurement system;

FIG. 5 illustrates a flow diagram of a process for identifying suppliers, in accordance with one embodiment of the present invention;

FIG. 6 illustrates a flow diagram of a process for creating and approving purchase agreements, in accordance with one embodiment of the present invention;

FIG. 7 illustrates a flow diagram of a process for evaluating and awarding a quote or a bid in accordance with one embodiment of the present invention;

FIG. 8 illustrates a flow diagram of a process for the creation and/or approval of a purchase agreement, in accordance with one embodiment of the present invention;

FIG. 9 illustrates a flow diagram of a process for uploading approved catalogs in accordance with one embodiment of the present invention;

FIG. 10 illustrates a flow diagram of a process for purchase order transmission, in accordance with one embodiment of the present invention;

FIG. 11 illustrates a flow diagram of a process for purchase order acceptance in accordance with one embodiment of the present invention; and

FIG. 12 illustrates a flow diagram of a process for shipping notification in accordance with one embodiment of the present invention.

### DETAILED DESCRIPTION

The present invention relates generally to an intermediate processing layer providing for the inclusion of procurement functionalities of a multi-level enterprise business application as well as additional add-on functionality covering interfacing customizations and enhancements. In one embodiment, the multi-level enterprise business application may be a Business Suite created by Oracle. The multi-level enterprise business application includes various levels of functionality but has limited intermediate level functionality. Through the present invention, the intermediate processing layer allows the operation of previously excluded processing operations by bridging processing and other operational gaps in the enterprise application.

The invention further includes the methodology for operating the procurement management system including numerous processing steps or operations, which may be guided in part based on software-based executable instructions or guidelines incorporated into or governing the executable operations. As described herein, the steps may be encoded by one having ordinary skill in the art for the performance of the indicated operation.

The procurement system includes four defined portals, a procurement portal, a sourcing portal, a reporting portal, and a supplier portal. The procurement system further includes additional levels of support, information or other layers of user interface. A first support layer is a system administration/helpdesk training application, a second support layer is a supplier helpdesk/services layer, a third layer is a analytics layer and the fourth support layer in this embodiment is a auction/RFQ/buyer administration and support layer.

These portals and layers are disposed within existing processing components of the business enterprise suite and provide an interactive component to various users, specifically through the portals. For example buyers may access the sourcing portal, management may access the reporting portal, suppliers may access the supplier portal and supply management personnel may access the procurement portal. Through these portals and layers, previously incongruent levels of processing application in the business enterprise suite are combined for multi-level processing capabilities.

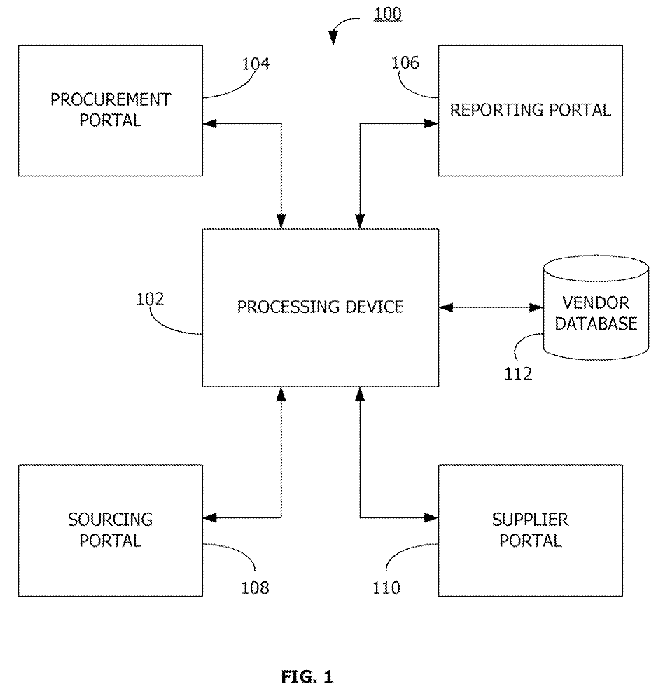

FIG. 1 illustrates a block diagram of one embodiment of a processing environment 100. The environment 100 includes a processing device 102, a procurement portal 104, a reporting portal 106, a sourcing portal 108, a supplier portal 110 and a vendor database 112.

The processing device 102 may be one or more processing devices operative to perform processing operations, including processing executable instructions for performing software-based operations. In one embodiment, the processing device may execute an existing enterprise-wide software application, such as an application available from Oracle. The processing device 102 may include numerous network processing devices (graphically not shown, but generally included in the processing device 102) executing the enterprise software application, where the various processing components further include additional storage and database accessing operations, as recognized by one having ordinary skill in the art. It is recognized that many known components for an enterprise processing system have been omitted for clarity purposes only, and rather shown generally as the processing device 102.

The procurement portal 104, reporting portal 106, sourcing portal 108 and the supplier portal 110 may be stand alone processing components based on one or more processing platforms. In another embodiment, one or more of the portals 104, 106, 108 and/or 110 (hereinafter collectively referred to as 104-110) may be integrated within the enterprise application running on the processing device 102. The portals 104-110 may include one or more processing devices operative to perform various operational functionalities, as described herein. Where one or more of the portals 104-110 are associated with or embedded in the enterprise application running on the processing device 102, the processing device 102 may perform the executable instructions for these particular platforms. The vendor database 112 may be one or more storage devices operative to store vendor information therein.

As described in further detail below, the supplier portal 106 may include functionality generated by software and executable code as executed on one or more processing devices. The functionality may include operations for viewing supplier agreements and blanket purchase order and associated releases, acknowledging purchase orders and submitting support documents, binding document with electronic signatures from suppliers, suppliers being allowed to submit online change requests that can be automatically routed for buyer approval, viewing purchase orders with header, line, shipment and time details along with related invoices and receipts, downloading postscript versions of the purchase orders, viewing purchase order history with revision details, managing contract deliverables and viewing contractor time cards. From a receiving perspective, the functionality of the supplier portal may include viewing open delivery schedules, entering, viewing and cancelling advance shipment notifications, uploading spreadsheets to create multiple advance shipping notifications, using identification numbers on shipment notices for flexible receiving, managing inbound logistics through routing requests, viewing receipt history, returns and inspection results, overdue receipts and on-time delivery performance.

The supplier portal 106 may further include functionality for entering and viewing invoices with attachments, entering billing information with advance shipment billing notification, viewing invoice status and received payments. Regarding planning and inventory, the supplier portal may allow updating supplier capacity on the Approved Supplier List (ASL), specifying supplier/item order modifiers such as minimum order quantity and lot quantity restrictions, defining supplier/item lead times, viewing on-hand inventory balances for sole-sourced items, supporting VMI processes, viewing consigned inventory and all associated transactions, viewing supplier forecast schedules and supplier shipping schedules. Regarding outside processing, the supplier portal may allow entering quality plans for shipments, planning and managing outside processing with the outside processing workbench, and viewing outside processing orders.

Regarding registration and security, the supplier portal 106 may include a self-service supplier profile management technique, prospective vendor registration, managing supplier user registration process, including direct registration by buyers and invitation to suppliers to self register, and restricting suppliers views to transactions on orders pertaining to his/her company or site. Regarding flexibility to support business, the supplier portal may include functionality for designing custom views of data for each supplier or user (e.g., hide fields, re-sequence fields, change column labels), configuring application flow to meet specific business needs, exporting data to spreadsheet format, providing global data access to suppliers across operating units, providing terms and conditions, item details and more, via supporting attachments, utilizing workflow process integration, transmitting notifications when a supplier submits a transaction, integrating with key complimentary applications of purchasing, supplier scheduling, payables, inventory, and sourcing.

As described in further detail below, the sourcing portal 108 may include functionality generated by software and executable code as executed on one or more processing devices. The functionality may include operations for facilitating multiple types and styles of negotiations, negotiation templates, sourcing professional collaboration and security, multi-currency transactions, multi-language support, multi-attribute weighted scoring, lot-based bidding, line groups, buyer and seller price factors, buyer and supplier price factors, location, time-phased and volume pricing, advanced supplier search, offline spreadsheet support, notes and attachments, supplier access control by event line, consolidated negotiation search, corporate terms and conditions, industry standard forms, negotiation synopsis in extranet website, sourcing events, negotiation postscript file format printing and event based notifications. Regarding negotiation management, the sourcing portal 106 may include functionality for various types of negotiations aspects, including pausing negotiations, allowing online discussions, looking particular parties out, monitoring party activity, copying or cancelling negotiations, negotiating amendments, multi-round negotiations, and reusable invitation, attribute, price factor lists.

Regarding supplier bidding, the sourcing portal 108 many include proxy bidding, power bidding, surrogate bidding, supplier response by supplier site, supplier participation acknowledgement, supplier registration, supplier profile management and supplier user management. Regarding analysis and awarding, the portal 108 may include online, side-by-side comparison, graphical monitors, transformation bidding, subject scoring of response, analysis scenarios, multiple award methods, award summary. award approvals, award determination and sharing, price break analysis and intelligence reports. Regarding award optimization, the portal may include business objectives and constraints modeling, award scenario optimization and what-if analysis. Regarding purchasing integration, the portal 108 may include functionality to generate purchase orders, integrate procurement demand, re-negotiate blanket agreements, negotiate encumbered requisitions, requisition visibility in sourcing, requisition allocation for partial and split award, and purchasing intelligence.

As described in further detail below, the reporting portal 110 may include functionality generated by software and executable code as executed on one or more processing devices. The functionality may include operations for end user features, such as dashboards with key performance indicators, graphs, tables, and links, key Performance Indicator table with KPI comparison graph, multi-dimensional reports, drill to transaction detail screens, drill to transaction entry screens to take action supporting closed loop business processes, growing repository of out-of-the-box content, role-based design provides insight across multiple functional areas, pass relevant parameters when drilling across dashboards and reports, daily period-to-date summarization provides year-to-date, quarter-to-date, month-to-date, and week-to-date summaries, relevant performance comparisons measure current period-to-date results compared to the same point in time in the prior period or prior year, common enterprise reporting calendar, primary and secondary global reporting currencies, export to Excel and PDF formats, send dashboards or reports by email, personalized related links and integration with a collaboration suite to initiate web conferences.

The reporting portal 110 may also include administrator features including enforcing existing E-Business Suite security rules, automatically generating programs to refresh summaries, an auto-refresh rate for overview pages and reports that are based on live data, renaming or disabling pre-built KPIs, hiding and rearranging regions on dashboards and creating new reports, KPIs, and dashboards based on custom EBS or non-EBS data sources. Regarding intelligence modules, the reporting portal 110 may include intelligence processing modules relating to financials, human resources, interaction intelligence, iStore, marking, PLM, purchasing, quoting, sales, service, service contracts and supply chain, by way of example.

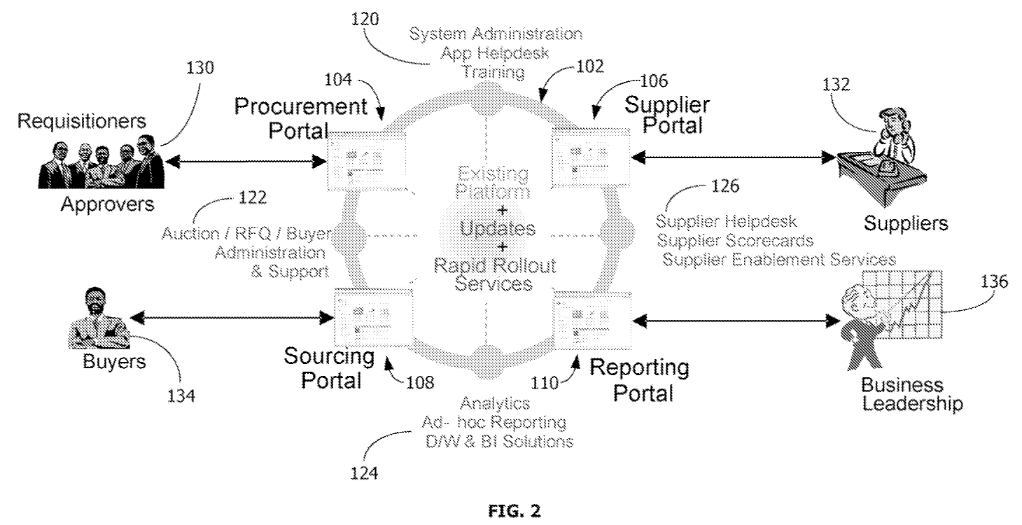

The operation of various embodiments of the portals 104-110 are described in FIG. 2, which illustrates the execution environment that includes the processing elements of FIG. 1. The environment includes components in the processing device, including existing enterprise software platform, various enterprise software updates and processing elements relating to the rollout of the software to various users, departments, processing platforms and other elements found with enterprise software solutions, hereinafter generally referred to as the central platform.

Graphically illustrated, the enterprise software platform includes four existing defined processing components, where the processing components represent one or more functional software applications for performing or facilitating the related processing tasks. A first processing component 120 includes a system administration, application help desk and training processing functions. A second processing component 122 relates to auction, request for quote, buyer, administration and support functionality. A third processing component 124 includes analytics, ad-hoc reporting functions and business intelligence solutions. A fourth processing component 126 includes supplier functionality, such as supplier help desk, supplier scorecards and supplier enabled services.

As illustrated in FIG. 2, the processing device 102 further includes the procurement portal 104, the supplier portal 106, the sourcing portal 108 and the reporting portal 110. Users who perform requisition operations and users who have access to approve the requisitions 130 may access the central platform through the procurement portal 104. Suppliers 132 may access the central platform through the supplier portal 106. Buyers 134 may access the central platform through the sourcing portal 108. Business leadership or other analyst user 136 may access the central platform through the reporting portal 110.

As described in further detail below, it is through these portals that various types of users are able to access and perform additional software functionality. While existing enterprise applications previously included interfacing functionality for different users, these previous interfaces where not specific to particular functions, but rather provide a general user interface. The additional portals provide directed and specific interfacing for specific users relating to the intended purpose of accessing and otherwise interacting with the enterprise application, and thereby improving system functionality and installation requirements as the portals are designated for particular users instead of formulating a general interface usable for all users.

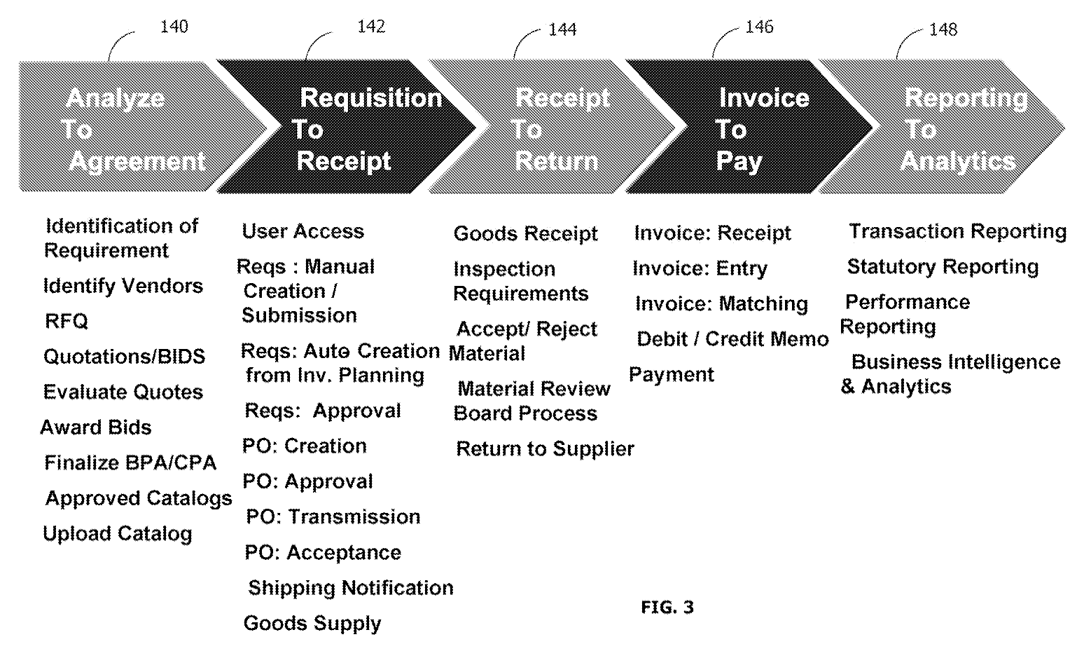

FIG. 3 illustrates a flow functionality process for multiple processing steps as performed by the portals, as illustrated in FIGS. 1-2, in conjunction with the central platform. Each of the processing procedures are discussed in further detail in the below, with FIG. 3 providing a general overview of the functionality procedure.

A first processing procedure is an analyze to agreement protocol 140. In one embodiment, this protocol 140 includes the listed steps of the identification of contract or procurement requirements, identification of vendors, a request for quote, the processing of quotation of bids, the evaluation of quotes, the awarding of bids, finalizing the acquisition matters, approve catalogs that may be used in a procurement process and uploading the approved catalog(s). In one embodiment, the protocol may include that the steps relating to the quote or bid may be optional and the procure to pay reference model 140 may be directed more specifically to the establishing of defined relationships and uploading of catalogs or other reference materials for commercial activities.

The second procedure 142 are the steps from a requisition to receipt. This procedure includes the steps of allowing user access and creating the submission, auto-generating the submission using an inventory planning application and the approval process, all for the requisition. In this procedure 142, additional steps relative to the purchase order include the creation, approval, transmission and acceptance, as well as the additional steps of shipping notification and the supply of the goods to confirm or otherwise quantify receipt. In one embodiment, this procedure 142 may include the steps relating to the auto-generation of the requisition, the purchase order acceptance and shipping notification may be optional.

The third procedure 144 are the steps from the receipt of goods to the return of goods. This procedure 144 may include the steps of receiving the goods, performing an inspection of the goods, the acceptance or rejection of various elements, a material review board process and the return of rejection or otherwise not accepted elements to the supplier. In one embodiment, the steps of between the receipt of the goods and the return of the goods to the supplier may be optional as inspection may not be required or other factors may indicate the goods to be automatically or otherwise returned.

The fourth procedure 146 are the steps from the receipt of an invoice to the payment of the invoice. This procedure 146 may include the receipt of the invoice, entering the invoice into the processing or procurement system and matching the invoice and elements to internal records. The procedure 146 may also include the generation of a debit or credit memo and the subsequent payment.

The fifth procedure 148 are the steps for the reporting of the particular transaction to the processing or generation of analytics. This procedure may include reporting various commercial transactions, executing various statutory reporting requirements, entering performance reporting information and subsequently the execution of the business intelligence and various analytic operations.

The various procedures 140, 142, 144, 146 and 148 provide for exemplary embodiments of executable procedures performed or otherwise facilitated by the various portals 104-110. The execution of the steps of these procedures allows for the processing and execution of the enterprise application.

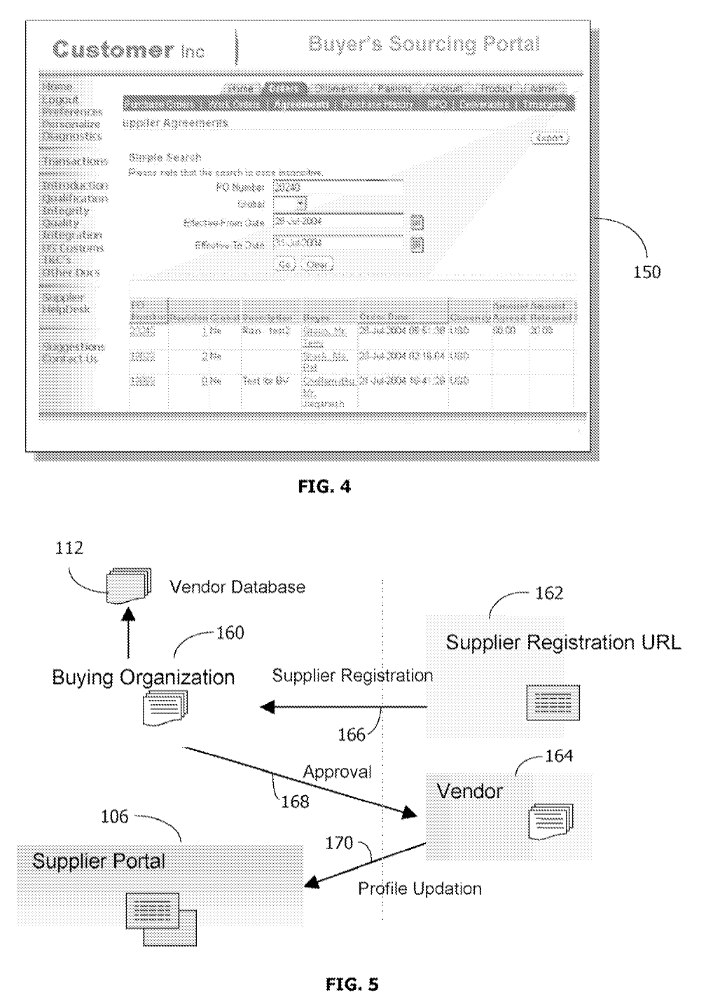

FIG. 4 illustrates a sample screenshot 150 for a buyer's sourcing portal. This screen shot 150 may be a visual interface as seen by a user, or a buyer (134 of FIG. 2). The sourcing portal 108 of FIG. 2 allows for the buyer 134 to access the central platform, and in one embodiment perform the steps of the procedure 140 of FIG. 3.

As illustrated in the sample screen shot 150, the buyer can access various electronic documents or other information that can be acquired from the enterprise application. This sample interface allows the tab buttons for examining order information, shipping information, planning information, account information and product information. Using standard interfacing techniques, the buyer is able to access the various amounts of information disposed within the enterprise application.

FIG. 5 illustrates a block diagram with the flow of executable steps for performing the analyze to agreement procedure. This procedure may be directed to the steps relating to the generation of an initial contract or agreement to conduct business. The block diagram of FIG. 5 includes the vendor database 112, a buyer organization 160, the supplier portal 106, a supplier registration Universal Resource Locator (URL) 162 and a vendor 164.

Existing enterprise software applications may include operations, such as a self service requisition entry, catalog searching to identify commonly bought items and spreadsheet based loading of item information for the creation of sourcing documents. With the inclusion of the portals, the processing environment may include inventory management modeling operations based on analytics of past consumption demands and the forecasting of future consumption demands. These additional processing steps may be made possible by the interfacing to the supplier portal to the central platform and functional processing or software-based operations encoded therein. In one embodiment, the forecasting operations may be performed using stochastic forecasting models, as recognized by one having ordinary skill in the art.

As illustrated in FIG. 5, the buying organization may receive supplier registration information 166. This registration information may be, in one embodiment, catalog or other information relating to or validating the supplier and the items the supplier is able to sell or otherwise offer to the buying organization 160. Should the buying organization 160 approve the supplier for business engagements, an approval 168 can be sent to a vendor 164, while the information is also stored in the vendor database 112. From the vendor 164, a profile update 170 can be provided to the supplier portal 106, thereby updating this information within the enterprise application on the central platform.

In the supplier identification procedure of FIG. 5, the existing enterprise application may include online registration procedures by prospective vendors, online supplier profile updates by vendors, manual approval of vendors, including approval via electronic mail communications. The inclusion of the portal may provide for the supplier master information being based on an existing external database source, such as for example of a Dun and Bradstreet® database, the inclusion of supplier integration guidelines within the portal, supplier evaluation procedures and the data management operations for cleansing and merging supplier-based information.

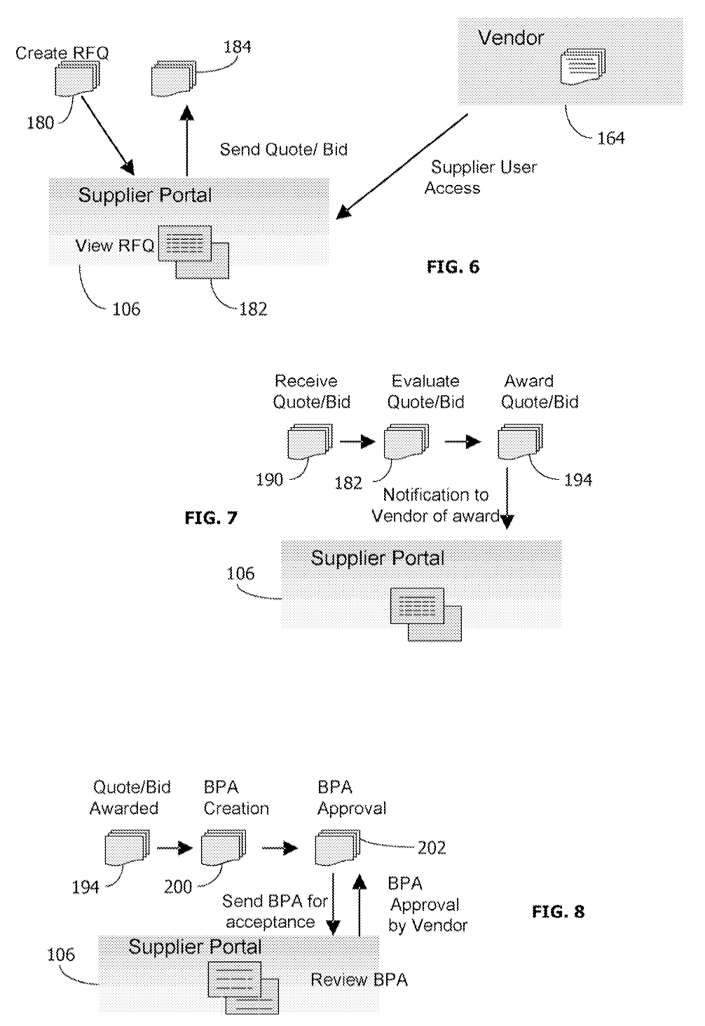

FIG. 6 illustrates another graphical illustration of a component of the analyze to agreement protocol, such as described above. FIG. 6 illustrates the steps of one embodiment of the request for quote creation and quote and bid response procedures. This procedure is executed through the supplier portal 106 and includes a request for quote (RFQ). A first step is the creation of the RFQ 180. Through the supplier portal 106, the RFQ 182 may be visible. Another step includes sending the quote or a bid 184. Additionally, a vendor 164 is granted access to the supplier portal for processing operations.

Standard functionality in this enterprise software application may include the instant creation of RFQs from previous agreements or the creation of the aggregation of various or numerous requests. The system may include the ability to attach documents to the RFQ, define auction attributes, restrict access of the RFQ to various suppliers or other parties, adjust or otherwise modify date terms, encourage bid process through reverse auctions, create and publish various amendments or rounds of negotiations to the master agreement, maintain an audit trail of the RFQ process, allow further analysis or examination of creditworthiness for various parties and the buyer may be able to view responses and bidding activities in a real time environment.

FIG. 7 illustrates the steps of the process of evaluating and awarding a bid or quote, as performed by the central platform, including accessibility to the platform through the supplier portal 106. This procedure includes receiving a quote or a bid 190, evaluating the bid 192 and awarding the quote or bid 194. This may be done using any of a variety of techniques, such as an automated technique when an auction or a bidding process expires, awarding the bid when a party matches certain criteria or in another exemplary embodiment, when a party manually approves the bid. Through the supplier portal, the procedure may include the notification of a vendor regarding the approval or awarding of the bid.

This procedure may include operations performed by the central platform including an automated bid scoring technique, providing consistent formatting for side-by-side comparison of competing bids, multiple charts and graphs for the bid information and business and regulatory compliance monitoring. Additionally, the procedure may also include the ability to view award summary for purchase recommendation, approval and compliance matters and the monitoring and execution of system generated recommendations, such as recommending a particular feature or service to one party based on aspects of the bid or transaction.

FIG. 8 illustrates the steps of the process of creating and approving a buyer's purchase agreement (BPA) as performed by the central platform in conjunction with the supplier portal 106. The procedure includes the awarding of the quote or bid 194, the creation of the BPA 200 and the approval of the BPA 202. The approval of the BPA may be performed through the supplier portal 106, including sending the BPA to the portal for acceptance and subsequent approval from a vendor accessing the portal.

Existing enterprise software applications may include procedures for the automated creation of the purchase agreement or a purchase order from the information in the system, generating a consistent formatting allowing a party to compare similar bids, ability to copy all pricing, contract and deliverable information from the bid to the agreement, the elimination of manual entry of this information and its subsequent errors and flexible workflow operations for individualized BPA or purchase order approval. The existing systems may additionally include the ability to forward-to, reassign-to and/or delegate the BPA or PO to different approval entities, electronic mail and web-based portal notification techniques, and the ability to view approval history and the current approver. Additionally, with the inclusion of the supplier portal 106, the processing environment includes the processing ability to execute pre-configured requisition workflow processes that are based off of existing best-practices operations for the user. These best-practices techniques are customizable based on the existing operational aspects to the user and easily integrated into the portal for subsequent operation execution using the enterprise software application.

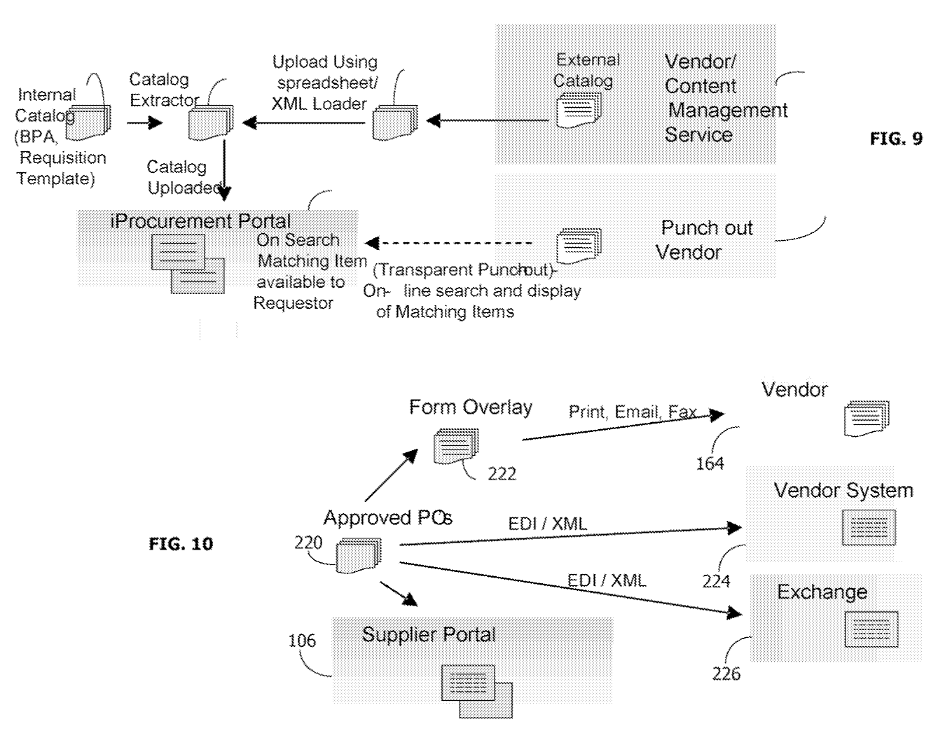

FIG. 9 illustrates the operational steps of one embodiment of the steps of uploading approved catalogs into the enterprise software application. This procedure is executable through the procurement portal 104. The procedure includes the extraction 210 of an internal catalog 212, where the catalog is the uploaded to the procurement portal 104. The internal catalog may be an old or existing catalog already stored in the enterprise processing environment, where a catalog is a collection of items offered for sale by one or more parties.

In addition, an external catalog 214 may be uploading 216 from a vendor content management service 218. The vendor content management service 218 may be any suitable type of service that provides catalog information, such as a network computer or even an inventory or other type of enterprise application, allowing for the distribution of the catalog or product information. In the illustrated procedure of FIG. 9, the catalog information may be uploaded using a spreadsheet or an extensible mark-up language loader, for example.

Additionally, the procedure of FIG. 9 may also include a punch out vendor 220, which is capable of providing matching supply items, such as in a cost-competitive acquisition comparison operation. For example, the punch out vendor 220 may access the procurement portal and allow a request to conduct searching operations to finding matching or similar inventor or catalog items.

A web shopping interface may be utilized, where this interface utilizes common online or electronic commerce features for improved user comfort, for example the interface may use an automated step through requisition process, as well as a powerful multi-field search engine for searching one or more catalogs or other fields of information such as the web. The system may also include information templates for making information available as well as smart forms for ordering items that may not be included in a particular catalog. Additionally, the interface may include sorting, filtering and/or ranking operations to present users with more accurate search result information. The shopping interface may also be customized using known customization procedures.

In the uploading of approved catalogs, existing enterprise applications may include functionality relating to the automatic creation of a catalog from an award, uploading spreadsheet or XML formatted data, pre-configuring templates available for subsequent data uploading and the transparent punch-out of catalogs being accessed and allowing for the determination of matching items retrieved for a requester.

In one embodiment, the procurement portal 104 may include an interface for employees to internally access procurement information. The procurement portal 104 may include workflow-based electronic requisition and approval procedures, applications or applets for training usage of the procurement functionalities and information reference on procurement policies.

In one embodiment, the supplier portal 106 may include an interface for suppliers to access the enterprise application. The portal 106 may include processing functions for digitizing supplier enablement, improving supplier integration of existing systems to the enterprise system and facilitate information reference and supplier outreach procedures.

In the procure to pay reference model of FIG. 3, in the requisition to receipt steps 142, the user access may include existing enterprise functionality of secured access for employees and suppliers across a web-portal, a robust security framework for access to data and system functionality and flexible support for global and/or local control of procurement functionalities. Additionally, through the inclusion of the portals operating in conjunction with the enterprise application, the central platform may also include the integration of customer single sign-on practices, pre-configured templates for user access in accordance with government or other regulatory provisions and pre-configuration for best-practice procurement roles and approval hierarchy. Additionally, the central platform may also include procedures for the automated upload of customer's employee information during platform deployment and the integration of customer's human resource management systems, if they are external to the central platform.

In the step of requisition creation and submission in the steps 142, existing enterprise applications may include functionality, including data templates for auto-populating data fields in a requisition document, default procedures or rules for pre-populating defined fields in the documents, and express requisition creation function, automated searching and linking of requisition items for various types of agreements and the secure attachment of types and categories of elements or items to a requisition document. With the inclusion of the portals and added functionality, the central platform may include additional features such as the automated upload of local supplier catalogs during platform deployment, ready to configure and deploy object codes for transparent and non-transparent punch-outs and ready to configure and deploy workflows for account generation based on, among other factors, best practice account standards, common vertical industry practice relevant to a particular customer and customer-specific business rules based on organization, cost center and other pertinent factors.

In the step of requisition approval in the steps 142, existing enterprise applications may include functionality providing for the flexible, digitized workflow-based requisition approval with advantage features like time-out capabilities, the capability to assign ad-hoc list of approvers, capability to forward, re-assign or delegate requisitions to one or more person capable of giving approval, electronic mail and web-based notifications from an approval workflow and the capability to view the approval history and the current approver. With the inclusion of the portals and the additional functions, the central platform may also include functionality for pre-configured, ready to use requisition approval workflow processes based on best-practices operations. The best-practices operations may be based on detailed analysis and determination of various process aspects, such as identifying who, how much, what, and why to particular requisition approval scenarios.

In the requisition to receipt steps 142, the step of purchase order creation may be partially performed by the existing enterprise application that includes functionality relating to flexible workflow procedures based on auto-creation of purchase order documents from approved requisitions and valid agreements, ad-hoc manual creation of purchase order documents, ad-hoc adding requisition lines to existing purchase order documents, flexibility to consolidate multiple requisition lines into a single purchase order line and the capability to return the requisition lines to the preparer. With the inclusion of the portals and the additional functions, the central platform may also include functionality for pre-configured, ready to use requisition approval workflow processes based on best-practices operations, similar to operations as described above. The procurement portal may include functionality based on programming steps for user-based shopping lists, saving shopping cart information, dynamically calculating pricing information, in any suitable currency, as users add or remove items.

In the requisition to receipt steps 142, the step of purchase order approval may be partially performed by the existing enterprise application that includes functionality relating to flexible workflow procedures based on purchase order approval, capability to assign ad-hoc list of approvers, capability to forward, reassign or delegate the purchase order to different approval parties, electronic mail or web-based notification of purchase order approval and the capability to view the approval history of the current approver. With the inclusion of the portals and the additional functions, the central platform may also include functionality for pre-configured, ready to use requisition approval workflow processes based on best-practices operations, similar to operations as described above. Also, the portal may include features relating to the processing of the purchase, including pre-populating address information, adjusting line items of an order such, tracking delivery information, by way of example.

In one embodiment, the procurement portal may also include functionality relating to policy enforcement. For example, procedures may include electronically checking funds availability prior to approval or processing credit-based cards. The procedures may include processing tax-exempt purchases or prioritizing charge accounts, as well as referencing any pre-existing contract compliance issues.

FIG. 10 illustrates block flow diagram of one embodiment of the steps relating to the purchase order transmission, as described in the requisition to receipt steps 142 of FIG. 3. The flow diagram may include various steps, based on the approved purchase order 220. This approved purchase order may be provided to the supplier portal 106, for distribution to the supplier (132 of FIG. 2) or can be distributed in additional techniques. One technique is the application of a form overlay 222, which allows for the form to be attached to or otherwise associated with one of a variety of transmission techniques for submission to the vendor 164. Sample transmission techniques may include print, electronic mail or a facsimile, but as recognized by one having ordinary skill in the art, other transmission forms are also envisioned herein. The approved purchase order 220 may be submitted to a vendor system 224 or a data exchange 226. In this embodiments, the approved purchase order 220 may be converted and transmitted in a mark-up language, electronic data interchange (EDI) formatting or any other acceptable formatting as recognized by one having ordinary skill in the art.

In the requisition to receipt steps 142, the step of purchase order transmission may be partially performed by the existing enterprise application that includes functionality relating to supplier industry standards for transmitting the purchase orders and allowing the viewing the purchase order agreements and the related documents. With the inclusion of the portals and the additional functions, the central platform may also include functionality for pre-configured workflow processes for transmitting the purchase order documents, as described above. Additionally, the system may also include pre-configured hooks or processing elements for interfacing with supplier systems or market-places exchanges using various formats, such as the XML or EDI formats.

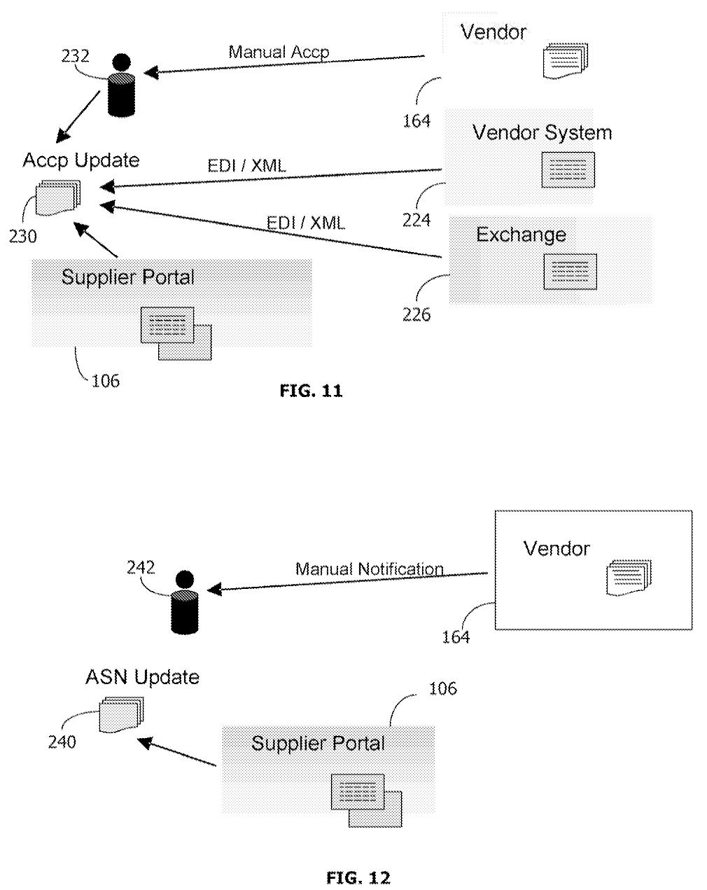

FIG. 11 illustrates a block diagram of the flow of operations of one or more embodiments relating to the step of purchase order acceptance, as part of the requisition to receipt steps 142 of FIG. 3. An acceptance update 230 may be provided by one or more of several techniques. One approach is a manual acceptance by a vendor 164 with a user 232. Another approach is an electronically encoded update, such as an EDI or XML update from either the vendor system 224 or the exchange 226. Additionally, the update 230 may be provided from the supplier portal 106.

Existing enterprise systems may provide existing functionality of supporting industry standard protocols for transmitting acceptances. With the inclusion of the portals, the central platform allows for the acceptance of field updates on purchase order documents, such as with manual or automated update features and the inclusion of pre-configuration hooks for interfacing with supplier systems or market-place exchanges, such as using XML or EDI, for example.

FIG. 12 illustrates a block diagram of the flow of operations of one embodiment of a shipping notification step, as part of the requisition to receipt steps 142. The vendor 164 may provide a manual notification to a user 240, where the user can then manually update the automated shipping notification 242. Additionally, through tracking of enterprise information, the shipping notification 242 may be updated by the supplier portal, for example the supplier portal receiving confirmation that a shipment of goods has been picked up by a carrier or interfacing with a commercial carrier's tracking system.

Existing enterprise systems may provide flexibility to send the shipping notification through a supplier's web portal and also allows the shipping notifications to be cancelled or resubmitted, as needed. Although, with the inclusion of the portals, the central platform includes the additional functionality of a web-portal for providing a supplier with information and transaction capability.

In the procedural steps of FIG. 3, the next steps relate to receipt to return 144. These operations may be performed in a variety of operations, using the portals and additional functionality in the central platform. One approach is an express receipt between a vendor and a delivery destination, without including a receiving department. This express procedure may include a delivery destination facilitating the return and updating the inventory and/or expense account. Another approach is a standard receipt operation, where unlike the express receipt, a receiving department may intercept and process the shipment of items. Another approach may be products that require inspection before full receipt, where accepted items are processed in the delivery destination and rejected items may be accepted by the receiver or returned. Upon the receipt of an unordered item, the receiving entity may filter received items based on whether the items match the purchase order agreement. Matching items are accepted and other items are thereby returned. Additionally, cascading receipt operations may also be performed using the enterprise application where quantity amounts of items are tracked where these items may be shipped in different shipments, therefore ongoing tracking of shipment of goods is monitored.

Steps relating to the additional functions in the procedures of invoice to payment 146 and the reporting to analytics 148 are provided in the enterprise application. For example, standard processing procedures may be used for processing invoice information and payment information. Additionally, standard processing procedures may be used for analytical operations. Although, these features enabled and available to the user now through different portals, such as the supplier portal and the reporting portal, respectively. For example, the reporting portal may include pre-defined reporting operations and a central interface allowing for a user accessing the portal to simply selected one or more of these designated analytical operations.

As such, the existing enterprise software applications are enhanced and improved through the inclusion of the above-described functionality in the disclosed portals. These portals improve user accessibility by allowing improved access to existing functionality and the inclusion of additional functionality complimenting the existing system.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for providing operative functionality between processing components of a procurement system, the apparatus comprising:
a central processing system operating the procurement system thereon, the central processing system including a processing device and a memory device having historical transaction data stored therein;
a procurement portal, a sourcing portal and a reporting portal, each of the portals in operative communication with the central processing system; and
a supplier portal for operative communication with the central processing system such that the processing device in the central processing system is operative to conduct inventory modeling operations based on the historical transaction data in response to a search request from the supplier portal.

2. The procurement system of claim 1 wherein the processing device is further operative to forecast future product consumption relating to inventory data based on the historical transaction data in response to a forecasting request from the supplier portal.

3. The procurement system of claim 2 wherein the forecasting is performed using stochastic models.

4. The procurement system of claim 1 further comprising:
a vendor database including a plurality of vendor profiles, the vendor database populated with a new vendor profile through the processing device, such that the vendor profiles are accessible through the supplier portal.

5. The procurement system of claim 4 wherein the supplier portal further includes supplier evaluation and qualification services.

6. The procurement system of claim 1 further comprising:
at least pre-configured best practices acquisition routine associated with a vendor and a supplier, wherein the steps of the routine are reviewable through the supplier portal.

7. The procurement system of claim 6 wherein the processing device further includes pre-configured regulatory recording processing steps executed through the processing operations in the supplier portal relative to the processing device.

8. The procurement system of claim 1 wherein the supplier portal is accessible through an Internet-based web portal connection.

9. An apparatus for providing operative functionality between processing components of a procurement system, the apparatus comprising:
a central processing system operating the procurement system thereon, the central processing system including a processing device and a memory device having historical transaction data stored therein;
a procurement portal, a sourcing portal and a reporting portal, each of the portals in operative communication with the central processing system;
a supplier portal for operative communication with the central processing system such that the processing device in the central processing system is operative to conduct inventory modeling operations based on the historical transaction data in response to a search request from the supplier portal; and
a vendor database including a plurality of vendor profiles, the vendor database populated with a new vendor profile through the processing device, such that the vendor profiles are accessible through the supplier portal.

10. The procurement system of claim 9 wherein the processing device is further operative to forecast future product consumption relating to inventory data based on the historical transaction data in response to a forecasting request from the supplier portal.

11. The procurement system of claim 10 wherein the forecasting is performed using stochastic models.

12. The procurement system of claim 9 wherein the supplier portal further includes supplier evaluation and qualification services.

13. The procurement system of claim 8 further comprising:
at least pre-configured best practices acquisition routine associated with a vendor and a supplier, wherein the steps of the routine are reviewable through the supplier portal.

14. The procurement system of claim 13 wherein the processing device further includes pre-configured regulatory recording processing steps executed through the processing operations in the supplier portal relative to the processing device.

15. The procurement system of claim 11 wherein the supplier portal is accessible through an Internet-based web portal connection.

16. An apparatus for providing operative functionality between processing components of a procurement system, the apparatus comprising:
a central processing system operating the procurement system thereon, the central processing system including a processing device and a memory device having historical transaction data stored therein;
a procurement portal, a sourcing portal and a reporting portal, each of the portals in operative communication with the central processing system;
a supplier portal for operative communication with the central processing system such that the processing device in the central processing system is operative to conduct inventory modeling operations based on the historical transaction data in response to a search request from the supplier portal; and
at least pre-configured best practices acquisition routine associated with a vendor and a supplier, wherein the steps of the routine are reviewable through the supplier portal, wherein the processing device further includes pre-configured regulatory recording processing steps executed through the processing operations in the supplier portal relative to the processing device and the supplier portal is accessible through an Internet-based web portal connection.

17. The procurement system of claim 16 wherein the processing device is further operative to forecast future product consumption relating to inventory data based on the historical transaction data in response to a forecasting request from the supplier portal.

18. The procurement system of claim 17 wherein the forecasting is performed using stochastic models.

19. The procurement system of claim 16 further comprising:
a vendor database including a plurality of vendor profiles, the vendor database populated with a new vendor profile through the processing device, such that the vendor profiles are accessible through the supplier portal.

20. The procurement system of claim 19 wherein the supplier portal further includes supplier evaluation and qualification services.
